(19) United States
(12) Patent Application Publication
(10) Pub. No.: US 2008/0010400 A1
(43) Pub. Date: Jan. 10, 2008

(54) Method and apparatus for automatically determining optimal access time of hard disk

(75) Inventor: Choon-kyoung Moon, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/642,785

(22) Filed: Dec. 21, 2006

(30) Foreign Application Priority Data
Jul. 6, 2006 (KR) 2006-63490

(51) Int. Cl. G06F 12/00

(52) U.S. Cl. 711/112

(57) ABSTRACT

A method for automatically determining an optimal access time in a hard disk, the method including determining an optimal access time of the hard disk based on an access time table in which optimal access times of the hard disk according to different environments are classified into a plurality of entry values and stored. Thus, an optimal hard disk access time can be automatically determined regardless of the change in the external environmental factors, such as temperature and humidity.

### CROSS-REFERENCE TO RELATED APPLICATION

This application claims the benefit of Korean Patent Application No. 2006-63490, filed on Jul. 6, 2006, in the Korean Intellectual Property Office, the disclosure of which is incorporated herein by reference.

### BACKGROUND OF THE INVENTION

1. Field of the Invention

Aspects of the present invention relate to a method and apparatus for automatically determining an optimal access time of a hard disk, and more particularly, to a method and apparatus for automatically determining an optimal access time of a hard disk in a PIO (program input/output) mode.

2. Description of the Related Art

Hard disks are auxiliary memory devices in computers, whereas main memory devices in computers refer to those devices present in the form of chips, such as ROM and RAM. The hard disk is a device to support the main memory device with the characteristics of being non-volatile (like the ROM), being capable of reading and writing (like the RAM), and having a large storage capacity.

Furthermore, the hard disk stores and executes an operating system (OS) to operate a computer. The OS has been developed together with personal computers (PCs). The ROM is not an appropriate device to store the OS because the ROM can be recorded only once and the cost per storage capacity is very high. Thus, the hard disk is important to the computer as a memory device capable of storing data for a long time, like the ROM. Also, as various multimedia capabilities surge with the development of the computer, the volume of data increases exponentially and high speed transmission and faster searches are needed. In this regard, the hard disk is the most efficient device. As the computer develops, the computer requires a device having a large capacity and long-term memory capability, although performance thereof is lower than that of the main memory devices. Thus, various memory devices have been developed and the hard disk that is presently used is considered as the most efficient device.

As the performance of the hard disk is improved, a demand for a faster transmission method of a hard disk controller increases. Thus, the basic transmission method of an integrated drive electronics (IDE) hard disk controller (an interface method connecting a hard disk in an AT compatible system) cannot satisfy the transmission speed of the present hard disk.

The IDE hard disk controller includes a direct memory access (DMA) mode and a processor input/output (PIO) mode. The PIO mode was first used in a hard disk of an enhanced IDE (EIDE) interface in which a central processing unit (CPU) processes all data. The EIDE interface connects a hard disk device to an industry standard architecture (ISA) bus. The EIDE interface increases the transmission speed from about 5 MB per second to 13.3 MB per second, the maximum storage capacity of a hard disk device to be accessed from 528 MB to 8.4 GB, and the number of peripheral devices to be accessed from 2 to 4. Also, the EIDE interface connects a CD-ROM using a protocol called an AT attachment packet interface (ATAPI). In the DMA mode, the transfer of data is processed without executing a program by the CPU. The PIO mode includes five modes, as shown in Table 1.

TABLE 1

PIO Mode 0: 3.3 Mbps
PIO Mode 1: 5.2 Mbps
PIO Mode 2: 8.3 Mbps
PIO Mode 3: 11.3 Mbps
PIO Mode 4: 16.6 Mbps
PIO Mode 5: 22.3 Mbps

However, the PIO Mode 5 has not been introduced to actual mass production, although it has been established and published. Thus, although the PIO Mode 5 is defined as above, only products corresponding to Mode 4 or less exist. The reason for the difficulty in realizing the PIO Mode 4 or more is that, unlike a CD-ROM using a laser as a pickup device, the hard disk uses a magnetic head has problems of heat and vibrations due to the high speed rotation of a disk and a limit in miniaturization of the head.

In the PIO Mode, the access time of the hard disk is fixed. The access time is obtained by adding a seek time to a latency time. The seek time refers to an average search time (the time needed for the head to search for a position) and usually indicated by “ms”. The value of the seek time lessens as the head searches for a position faster. As the seek time value decreases, the hard disk has a faster performance. In general, a 3-4 GB hard disk has a seek time of 9-12 ms. Also, the latency time refers to the time to identify a correct position of a file or data in a track.

FIG. 1 is a flow chart explaining a method to determine an optimal access time in a conventional hard disk. Referring to FIG. 1, in Operation 102, when a hard disk boots, a default access time of the hard disk is determined. In Operation 104, a device driver of the hard disk is initialized. In Operation 106, the access time of the hard disk is transmitted to the device driver.

In the PIO mode, since the access time is fixed to a default access time, an access time determined in an optimal condition cannot be applied and an access time in the worst condition is selected for a stable operation of the hard disk. Thus, in the PIO mode of the conventional hard disk, since the fixed access time is used even when a read/write cycle can be shortened, the performance cannot be improved.

### SUMMARY OF THE INVENTION

Aspects of the present invention provide a method and apparatus for automatically determining an optimal access time in a hard disk.

According to an aspect of the present invention, a method for automatically determining an optimal access time in a hard disk comprises determining an optimal access time of the hard disk based on an access time table in which optimal access times of the hard disk for a plurality of environments are classified and stored as a plurality of entry values.

According to another aspect of the present invention, the method further comprises setting a predetermined entry value as an entry count value signifying an entry value applied to the hard disk, checking whether the hard disk operates normally while changing the entry value when the entry count value is set, and setting the predetermined entry value as a final entry value signifying the optimal access time when the hard disk is checked to be normally operated.

According to still another aspect of the present invention, the method further comprises setting an entry count value when the error is generated as the entry count value when an error is generated during a reading or writing of data with respect to the hard disk, checking whether the hard disk operates normally with while changing the entry value based on the set entry count value, and setting the predetermined entry value as the final entry value signifying the optimal access time when the hard disk is checked to be normally operated.

According to yet another aspect of the present invention, the method further comprises setting as the entry count value an entry value at which the hard disk is most stably operated among the entry values based on the access time table when power of the hard disk is turned on, initializing a device driver of the hard disk by transmitted the entry count value, and setting the entry count value as the final entry count value based on the device driver when a user does not want to determine the optimal access time of the hard disk.

According to another aspect of the present invention, the entry values are classified from Entry 1 to Entry n by checking whether the hard disk operates normally while changing environmental factors and selecting an access time at which the hard disk is operated at the fastest speed in the environment.

According to still another aspect of the present invention, checking whether the hard disk operates normally includes at least one of: performing a diagnostic test on the hard disk, checking whether an ID of the hard disk is read, and reading a master boot record (MBR) before the entry value is set and storing the read MBR as a reference MBR and reading the MBR again after the entry value is set and checking whether the read MBR matches the reference MBR.

According to another aspect of the present invention, the method further comprises setting the entry count value as a final entry count value when the entry count value is an entry value at which the hard disk is most stably operated.

According to another aspect of the present invention, an apparatus for automatically determining an optimal access time of a hard disk comprises an access time table to classify and store optimal access times of the hard disk for a plurality of environments as a plurality of entry values, and an entry count setting unit to set an entry count value, which is an entry value applied to the hard disk, as a final entry count value, which is an optimal access time, based on the access time table.

According to another aspect of the present invention, the apparatus further comprises a hard disk status checking unit to check whether the hard disk operates normally, wherein the entry count setting unit sets a predetermined entry value as a final entry value signifying an optimal access time when the hard disk is checked to be operating normally with the predetermined entry value as an access time.

According to another aspect of the present invention, the access time table stores the entry values by checking whether the hard disk operates normally while changing environment factors, selecting an access time at which the hard disk is operated at the fastest speed in the respective environment, and classifying the selected access time from Entry 1 to Entry n.

According to another aspect of the present invention, the apparatus further comprises an MBR storing unit to read an MBR that is the first sector of the hard disk and to store the read MBR as a reference MBR, wherein the hard disk status checking unit performs at least one of: performing a diagnostic test for the hard disk, checking whether an ID of the hard disk is read, and reading the MBR again after the entry value is set and checking whether the read MBR matches the reference MBR.

According to yet another aspect of the present invention, the entry count setting unit sets as the entry count value an entry value at which the hard disk is most stably operated among the entry values based on the access time table when power of the hard disk is turned on, initializes a device driver of the hard disk by transmitting the entry count value, and sets the entry count value as the final entry count value based on the device driver when a user chooses to not determined the optimal access time.

According to another aspect of the present invention, when the entry count value is an entry value at which the hard disk is most stably operated, the entry count setting unit sets the entry count value as the final entry count value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart explaining the conventional hard disk access time determination method;

FIG. 2 is a diagram showing an apparatus to automatically determine an optimal access time of a hard disk according to an embodiment of the present invention;

FIG. 3 is a diagram explaining an access time table according to an embodiment of the present invention;

FIG. 4 is a flow chart explaining a method to automatically determine an optimal access time of a hard disk during a booting process according to an embodiment of the present invention;

FIG. 5 is a flow chart explaining a method to check the operation of a hard disk according to an embodiment of the present invention; and

FIG. 6 is a flow chart explaining a method to automatically determine an optimal access time of a hard disk during operation according to an embodiment of the present invention.

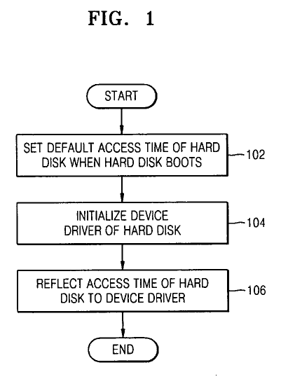

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

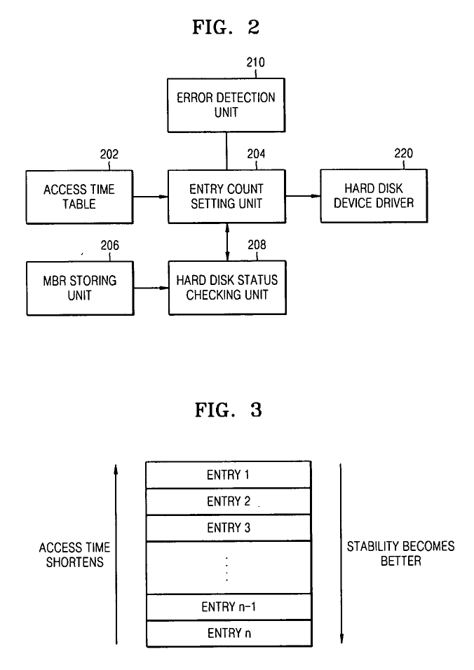

FIG. 2 is a diagram showing an apparatus to automatically determine an optimal access time of a hard disk according to an embodiment of the present invention. Referring to FIG. 2, the apparatus to automatically determine an optimal access time of a hard disk includes an access time table 202, an entry count setting unit 204, a master boot record (MBR) storing unit 206, a hard disk status checking unit 208, and an error detection unit 210. A hard disk device driver 220 is further illustrated to conveniently explain aspects of the present invention.

The access time table 202 stores optimal access times of the hard disk according to different environmental factors by classifying the optimal access times into a plurality of entry values. The environmental factors include, but are not limited to, temperature, humidity, and voltage. When the temperature, humidity, and voltage are not appropriate, the hard disk malfunctions or does not work at all. Thus, a slow access time at which the hard disk can be stably operated is generally used.

FIG. 3 is a diagram explaining the access time table 202 according to an embodiment of the present invention. Referring to FIG. 3, an access time gradually increases from Entry 1 to Entry n while the access time gradually decreases from Entry n to Entry 1. However, contrary to the access time, stability is better from Entry 1 to Entry n and worse from Entry n to Entry 1.

For example, when the environment is poor, the hard disk does not work in Entry 1 when the access time is short. However, in Entry 2 at which the access time is relatively slower, the hard disk can be operated because stability is better than in Entry 1. In this case, the entry count value is set to Entry 2 so that the hard disk is operated.

The entry values of the access time table 202 are determined by experiments according to an aspect of the invention. That is, by checking the operation of a hard disk while changing environmental factors such as temperature and humidity, the entry modes are classified from Entry 1 to Entry n by selecting an access time at which the hard disk can be operated at the fastest speed in the respective environment. As described above, Entry 1 is a mode when the access time is shortest and Entry n is a mode when the access time is longest. However, it is understood that one or all of the entries can be otherwise described, such as through modeling of the access times in addition to or instead of through experimentation.

Referring to FIG. 2, the entry count setting unit 204 sets an entry count value that signifies an entry value applied to the hard disk based on the access time table 202. When the hard disk is not normally operated, the entry count value is increased by 1. When the, hard disk is normally operated, the present entry count value is set as a final entry count value and transmitted to the hard disk device driver 220. When the entry count value is Entry n (the final entry value), Entry n is set as the final entry count value.

The MBR storing unit 206 reads an MBR, which is the first sector of the hard disk, and stores the same as a reference MBR. In detail, the MBR is a record that is first read from a disk when a computer is first booted. The MBR refers to information to identify the position of an OS and load the OS on a main memory device of the computer when the computer starts, and is stored in the first sector of the hard disk or floppy disk. The reference MBR is used later to check how the hard disk is normally operated.

The hard disk status checking unit 208 checks whether the hard disk is normally operated. While not required in all aspects, the status of the hard disk is checked in a method of performing a diagnostic test, a method of checking whether a hard disk ID is read, and/or a method of reading the MBR and checking whether the read MBR matches the reference MBR.

The diagnostic test program is included in the hard disk itself. When a desired value is output in response to a diagnostic test command, the hard disk passes the diagnostic test and the hard disk is determined to be operating normally. When a value other than the desired value is output, the hard disk fails to pass the diagnostic test and the hard disk is determined to not be operating normally.

In the method of checking whether a hard disk ID is read, since the hard disk cannot read an ID when the environment is poor, the hard disk can be determined to be operating normally when the ID of the hard disk can be read. The ID of the hard disk records additional information, such as the storage capacity, model number, and a manufacturer of the hard disk.

In the method of reading the MBR and checking whether the read MBR matches a reference MBR, when the read MBR does not match the reference MBR, the hard disk is determined to not be operating normally. When the access time is too short (the operation speed of the hard disk is too fast), data stored in the MBR may be broken. The mismatch of the MBR and the reference MBR signifies that data is broken so that the hard disk is not operating normally.

The error detection unit 210 detects whether an error is generated during a process of reading or writing data with respect to the hard disk. A time out method is used in the present embodiment as a method to detect an error. According to the time out method, when a particular command is input and no response thereto exists for a predetermined time period, an error is determined to have occurred. However, the error detection method is not limited to the above-described time out method and a variety of error detection methods can be used according to other aspects.

The hard disk device driver 220 operates the hard disk based on the final entry count value. That is, the hard disk device driver operates the hard disk using the optimal access time when the final entry count value is determined by the entry count setting unit 204.

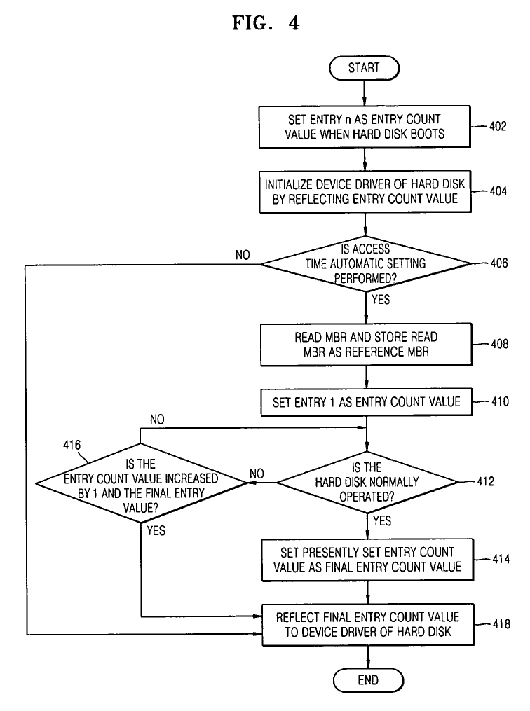

FIG. 4 is a flow chart explaining a method to automatically determine an optimal access time of a hard disk during a booting process according to an embodiment of the present invention. Referring to FIG. 4, in operation 402, when the hard disk boots, Entry n, the final entry value of the entry values, is set as an entry count value based on the access time table 202. In operation 404, the device driver 220 of the hard disk is initialized by using the set entry count value. That is, since Entry n is already set as the entry count value, the value with Entry n is transmitted to the device driver 220 of the hard disk.

In operation 406, it is determined whether a hard disk access time automatic setting is performed after the initialization. When the access time automatic setting is not performed, in operation 404, Entry n set as the entry count value becomes the final entry count value in operation 418. However, it is understood that if Entry n is not the last entry time, an entry with a lower access time or a higher value than n can be used in other aspects.

In operation 408, when the access time automatic setting is performed, the MBR is read and the read MBR is stored as a reference MBR. The reason for doing so is that the reference MBR is used to check whether the hard disk operates normally. In operation 410, Entry 1 is set as the entry count value. In operation 412, whether the hard disk operates normally is checked.

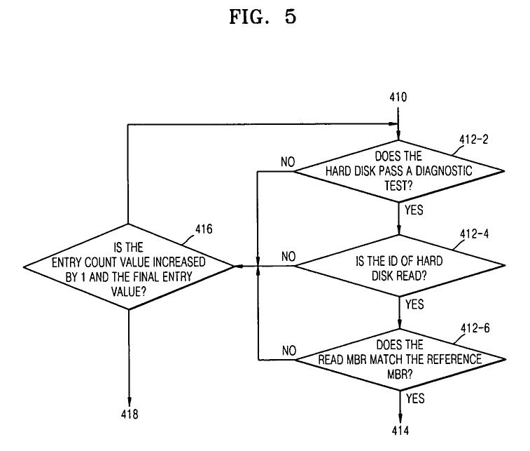

The methods of checking whether the hard disk operates normally include the method of performing a diagnostic test, the method of checking whether the hard disk ID is read, and the method of reading the MBR and checking whether the value matches the reference MBR. The operation of the hard disk status checking unit 208 including the above methods will be described with reference to FIG. 5.

In operation 414, when the hard disk is operating normally, the presently set entry count value is set as the final entry count value. In operation 416, when the hard disk is not operating normally, the entry count value is increased by 1 and it is determined whether the new entry count value is the final entry value (Entry n). When the entry count value is not the final entry value (Entry n), whether the hard disk is operating normally is checked again and the entry count value is increased by 1 until the hard disk operates normally or the entry count value is Entry n. However, when the entry count value is Entry n, Entry n becomes the final entry count value.

For example, when the hard disk is not operating normally when the entry count value is Entry 1, the entry count value is set as Entry 2. At this time, since Entry 2 is not the final entry value (Entry n), it is checked whether the hard disk is operating normally. When the hard disk operates normally, the present set entry count value is set as the final entry count value. However, it is understood that the value can be otherwise adjusted, such as by using Entry n-1, n-2, . . . to Entry 1.

In operation 418, the final entry count value is transmitted to the hard disk device driver 220. When the final entry count value is transmitted to the hard disk device driver 220, an optimal access time of the hard disk is set so that the hard disk can be operated at a fastest possible speed in a given environment.

FIG. 5 is a flow chart explaining a method to check the operation of a hard disk according to an embodiment of the present invention. Referring to FIG. 5, in operation 412-2, a diagnostic test of a hard disk is performed. When the hard disk passes the diagnostic test of the hard disk, the hard disk is determined to be operating normally and it is next checked whether a hard disk ID is read (operation 412-4). However, when the hard disk fails to pass the diagnostic test, the hard disk is determined to not be operating normally and the operation 416 in which the entry count value is increased by 1 is performed.

In operation 412-4, it is checked whether the hard disk ID is read. When the hard disk ID is read, the hard disk is determined to be operating normally and the MBR is then read and checked against the reference MBR (operation 412-6). When the hard disk ID is not read, the hard disk is determined to not be operating normally and the operation 416 in which the entry count value is increased by 1 is performed.

In operation 412-6, the MBR is read and it is checked whether the MBR matches the reference MBR. When the read MBR matches the reference MBR, the hard disk is determined to be operating normally so that, in operation 414, the presently set entry count value is set as the final entry count value. When the read MBR fails to match the reference MBR, the hard disk is determined to not be operating normally and the operation 416 in which the entry count value is increased by 1 is performed.

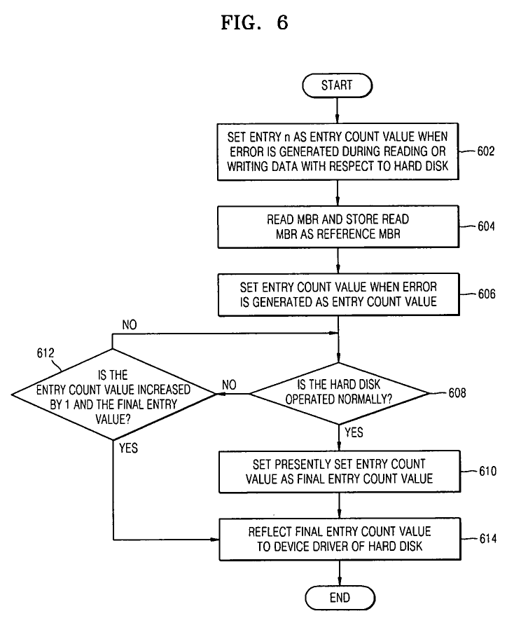

FIG. 6 is a flow chart explaining a method to automatically determine an optimal access time of a hard disk during operation according to an embodiment of the present invention. Referring to FIG. 6, in operation 602, when an error is generated during a reading or writing of data with respect to the hard disk, the final entry value (Entry n) based on the access time table 202 is set as an entry count value. The reason for doing so is that the MBR cannot be read when the hard disk is not operating normally during the present entry count value. Thus, the most stable entry (Entry n) is set as the entry count value to read the MBR. It is understood that, according to an aspect, the above-described time out method can be used as a method to detect an error.

In operation 604, the MBR is read and stored as the reference MBR. The stored reference MBR is used to check the normal operation of the hard disk. In operation 606, the entry count value when the error is generated is set as the entry count value. That is, increasing the entry count value from the entry value when the error is generated to Entry n is more efficient than increasing the entry count value from Entry 1 to Entry n. For example, when Entry 10 is an optimal access time and Entry 5 is the entry count value when an error is generated, it is more efficient to check the normal operation of the hard disk in order from Entry 5 to Entry 10 than from Entry 1 to Entry 10.

Since operations 608 through 614 are the same as the operations 412 through 418 of FIGS. 4 and 5, detailed descriptions thereof will be omitted herein.

Aspects of the present invention can also be embodied as computer-readable codes on a computer-readable recording medium and can be realized in a common digital computer executing the program using a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the Internet). The computer-readable recording medium can also be distributed over network coupled computer systems so that the computer-readable code is stored and executed in a distributed fashion. Moreover, the hard disk drive can be used with a computer, can be a portable drive, and/or can be used with a media player.

As described above, according to aspects of the present invention, an optimal hard disk access time can be automatically determined regardless of the change in the external environmental factors, such as temperature and humidity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for automatically determining an optimal access time in a hard disk, the method comprising:
selecting the optimal access time of the hard disk from a plurality of entry values according to a detected environment of the hard disk, wherein
a first entry value is a first access time and a second entry value is a second access time other than the first access time.

2. The method as claimed in claim 1, wherein the plurality of entry values are stored in an access time table in the hard disk.

3. The method as claimed in claim 1, wherein the plurality of entry values correspond to a plurality of environments, such that the first access time is an optimal access time of a first environment, and the second access time is an optimal access time of a second environment.

4. The method as claimed in claim 3, wherein the selecting of the optimal access time comprises determining an environment of the hard disk and determining the optimal access times to be one of the plurality of entry values corresponding to the determined environment.

5. The method as claimed in claim 1, wherein the selecting of the optimal access time comprises:
selecting one of the first and second entry values having a shortest access time value during which the hard disk operates normally.

6. The method as claimed in claim 5, wherein the selecting of the one of the first and second entry values comprises:
setting the first entry value as an entry count value, signifying a test access time applied to the hard disk;
checking whether the hard disk operates normally while the entry count value of the first entry value is applied as the test access time; and
setting the first entry value as a final entry value, signifying the optimal access time, when the hard disk is checked to be operating normally.

7. The method as claimed in claim 6, further comprising:
setting the second entry value as the entry count value when the hard disk is checked to not be operating normally while at the first entry value, wherein the second access time is longer than the first access time.

8. The method as claimed in claim 6, further comprising:
setting the second entry value as the final entry value when the hard disk is checked to not be operating normally while at the first entry value, wherein the second access time is a longest access time from among the plurality of entry values.

9. The method as claimed in claim 7, wherein the first access time is a shortest access time from among the plurality of entry values.

10. The method as claimed in claim 7, further comprising:
detecting an error during a reading or writing of data from/to the hard disk before the selecting of the optimal access time, wherein
the first access time is an access time of the hard disk when the error occurs.

11. The method as claimed in claim 1, further comprising:
setting a boot access time of the hard disk to a most stable access time from among the plurality of entry values when power of the hard disk is turned on and before the selecting of the optimal access time.

12. The method as claimed in claim 11, wherein the determining of the optimal access time comprises:
setting the boot access time as a final access time when a user chooses to not determine the optimal access time.

13. The method as claimed in claim 2, further comprising:
determining an access time at which the hard disk operates at a fastest speed for each of a plurality of environments, wherein the determined access time has a corresponding entry value, of the plurality of entry values, in the access time table.

14. The method as claimed in claim 6, wherein
the checking of whether the hard disk operates normally comprises:
reading a master boot record of the hard disk; and
checking the read master boot record against a reference master boot record, and
the hard disk is determined to not be operating normally when the read master boot record does not match the reference master boot record.

15. The method as claimed in claim 14, further comprising:
reading and storing the reference master boot record of the hard disk before the selecting of the optimal access time.

16. The method as claimed in claim 6, wherein
the checking of whether the hard disk operates normally comprises:
attempting to read an ID of the hard disk, and
the hard disk is determined to not be operating normally when the ID of the hard disk cannot be read.

17. The method as claimed in claim 6, wherein
the checking of whether the hard disk operates normally comprises:
performing a diagnostic test on the hard disk, and
the hard disk is determined to not be operating normally when the hard disk fails the diagnostic test.

18. The method as claimed in claim 1, wherein the selecting of the optimal access time comprises:
determining a final entry value, signifying the optimal access time, to be a value, of the plurality of entry values, during which the hard disk is most stably operated.

19. An apparatus for automatically determining an optimal access time of a hard disk, the apparatus comprising:
a memory storing an access time table to store a plurality of entry values corresponding to a plurality of environments, wherein a first entry value corresponds to a first optimal access time in a first environment and a second entry value corresponds to a second optimal access time in a second environment; and
an entry count setting unit to set one of the plurality of entry values as a final entry count value, signifying the optimal access time, according to an environment of the hard disk as compared to the entry values in the access time table, such that the final entry count value most closely corresponds to the environment in the access time table.

20. The apparatus as claimed in claim 19, further comprising a hard disk status checking unit to check whether the hard disk is operating normally,
wherein the entry count setting unit sets a shortest access time from among the plurality of entry values during which the hard disk is checked to be operating normally as the final entry count value.

21. The apparatus as claimed in claim 20, wherein:
the entry count setting unit sets the first entry value as an entry count value, signifying a test access time applied to the hard disk;
the hard disk status checking unit checks whether the hard disk operates normally while the entry count value of the first entry value is applied as the test access time; and
the entry count setting unit sets the first entry value as the final entry count value when the hard disk is checked to be operating normally while the entry count value is applied as the test access time.

22. The apparatus as claimed in claim 21, wherein the entry count setting unit sets the second entry value as the entry count value when the hard disk is checked to not be operating normally while at the first entry value, wherein the second optimal access time is longer than the first optimal access time.

23. The apparatus as claimed in claim 21, wherein the entry count setting unit sets the second entry value as the final entry count value when the hard disk is checked to not be operating normally, wherein the second optimal access time is a longest access time from among the plurality of entry values.

24. The apparatus as claimed in claim 22, wherein the first optimal access time is a fastest access time from among the plurality of entry values.

25. The apparatus as claimed in claim 20, further comprising an error detection unit to detect an error during a reading or writing of data from/to the hard disk, wherein when the error is detected:
the entry count setting unit sets the first entry value as an entry count value, signifying a test access time applied to the hard disk, wherein the first optimal access time is an access time of the hard disk when the error occurs;
the hard disk status checking unit checks whether the hard disk operates normally while the entry count value of the first entry value is applied as the test access time;
the entry count setting unit sets the first entry value as the final entry count value when the hard disk is checked to be operating normally while the entry count value is applied as the test access time; and
the entry count setting unit sets the second entry value as the entry count value when the hard disk is checked to be not operating normally while the entry count value is applied as the test access time, the second optimal access time being longer than the first optimal access time.

26. The apparatus as claimed in claim 19, wherein the access time table stores the plurality of entry values by determining an access time at which the hard disk operates at a fastest speed for each of the plurality of environments, wherein the determined access time has a corresponding entry value, of the plurality of entry values, in the access time table for an environment, of the plurality of environments.

27. The apparatus as claimed in claim 21, wherein the hard disk status checking unit reads a master boot record (MBR) of the hard disk and checks the read master boot record against a reference MBR, wherein the hard disk is determined to not be operating normally when the read MBR does not match the reference MBR.

28. The apparatus as claimed in claim 27, further comprising an MBR storing unit to read and to store the reference MBR before determining the optimal access time.

29. The apparatus as claimed in claim 21, wherein
the hard disk status checking unit attempts to read an ID of the hard disk, and
the hard disk is determined to not be operating normally when the ID of the hard disk cannot be read.

30. The apparatus as claimed in claim 21, wherein
the hard disk status checking unit performs a diagnostic test on the hard disk, and
the hard disk is determined to not be operating normally when the hard disk fails the diagnostic test.

31. The apparatus as claimed in claim 19, wherein the entry count setting unit sets a boot access time of the hard disk to a most stable value of the plurality of entry values, based on the access time table, when power of the hard disk is turned on.

32. The apparatus as claimed in claim 31, wherein the entry count setting unit sets the boot access time as the final entry count value when a user chooses to not determine the optimal access time.

33. The apparatus as claimed in claim 19, wherein the entry count setting unit sets the final entry count value to be a value, of the plurality of entry values, during which the hard disk is most stably operated.

34. An apparatus for automatically determining an optimal access time of a hard disk, the apparatus comprising:
a memory to store an access time table storing a plurality of entry values corresponding to a plurality of access times; and
an entry count setting unit to determine an optical access time to be used by a hard disk driver by:
selecting from the stored access time table a first entry value with a first access time,
if the hard disk operates normally at the first access time, setting the selected first entry value as the optimal access time, and
if the hard disk does not operate normally at the selected first entry value, selecting from the stored access time table a second entry value with a second access time greater than the first access time, and setting the selected second entry value as the optimal access time if the hard disk operates normally at the second access time.

35. The apparatus as claimed in claim 34, wherein
the entry count setting unit sets the second optimal access time as the optimal access time if the hard disk does not operate normally at the selected first entry value and the second optimal access time is a longest access time from among the plurality of entry values in the stored access time table.

36. The apparatus as claimed in claim 34, further comprising a hard disk status checking unit to check whether the hard disk is operating normally, wherein the entry count setting unit sets a shortest access time from among the plurality of entry values in the stored access time table during which the hard disk is checked to be operating normally as the optimal access time.

37. The apparatus as claimed in claim 36, wherein
the hard disk status checking unit reads a master boot record (MBR) of the hard disk and checks the read master boot record against a reference MBR, and
the hard disk is determined to not be operating normally when the read MBR does not match the reference MBR.

38. The apparatus as claimed in claim 37, further comprising an MBR storing unit to read and to store the reference MBR before determining the optimal access time.

39. The apparatus as claimed in claim 36, wherein
the hard disk status checking unit attempts to read an ID of the hard disk, and
the hard disk is determined to not be operating normally when the ID of the hard disk cannot be read.

40. The apparatus as claimed in claim 36, wherein
the hard disk status checking unit performs a diagnostic test on the hard disk, and
the hard disk is determined to not be operating normally when the hard disk fails the diagnostic test.

41. A computer-readable medium encoded with the method of claim 1 implemented by a computer.
